(19) United States
(12) Patent Application Publication
(10) Pub. No.: US 2013/0036093 A1
(43) Pub. Date: Feb. 7, 2013

(54) Reliable Writing of Database Log Data

(71) Applicants: Gernot Heiser, Eveleigh (AU); Aleksander Budzynowsi, Coogee (AU)

(72) Inventors: Gernot Heiser, Eveleigh (AU); Aleksander Budzynowsi, Coogee (AU)

(73) Assignee: National ICT Australia Limited, Eveleigh, NSW (AU)

(21) Appl. No.: 13/516,188

(22) PCT Filed: Dec. 17, 2010
(86) PCT No.: PCT/AU10/01699

§ 371 Date: Jul. 20, 2012

(30) Foreign Application Priority Data
Dec. 17, 2009 (AU) 2009906111
Aug. 9, 2010 (AU) 2010903555

(51) Int. Cl. G06F 7/00; G06F 17/30

(52) U.S. Cl. 707/634; 707/E17.007; 707/E17.005

(57) ABSTRACT

The invention concerns reliable writing of database log data, In particular, the invention concerns a computer system, methods and software to enable database log data to be written to recoverable storage in a reliable way. There is provided a computer system (100) for writing database log data to recoverable storage (60) comprising a durable database management system (DBMS) (40); and a hypervisor (80) or kernel 81 that enables communications between the recoverable storage device driver (52) and a recoverable storage device (60) to write the log data written to the non recoverable storage (92) and (42) to the recoverable storage device (60) asynchronously to the continued writing of log data to the non-recoverable storage (42) and (92). This allows the DBMS (40) to ensure recoverability and serializability and still allowing logs to be written asynchronously removing a performance bottleneck for the DBMS.

### TECHNICAL FIELD

The invention concerns reliable writing of database log data. In particular, the invention concerns a computer system, methods and software to enable database log data to be written to recoverable storage in a reliable way.

### BACKGROUND ART

Database systems are designed to reliably maintain complex data and ensure its consistency and stability under concurrent updates and potential system failures.

The concept of a transaction helps to achieve this. A transaction is a sequence of operations on a database that takes an initial state of the database and modifies it into a new state.

The challenge is to do this in an environment where multiple concurrent users perform transactions on the database, and where the system may crash at any time during transactions.

These two issues constitute the core system-level requirements on database management systems (DBMSes): isolation and durability. Core to addressing these requirements is the atomic nature of transactions. A transaction must be performed in its entirety or not at all (atomicity). Once performed, its effect must remain visible, even if the system fails (durability).

In order to achieve atomicity, transactions are explicitly bracketed by initiate-commit or initiate-abort actions. Once a transaction is initiated, it continues to operate on the state the database was in at initiation time, no matter what other transactions happen. Until a transaction is committed, its effects are invisible to any other user of the database. Once the transaction is committed, the effects are visible to all users. This is a consequence of the requirement of atomicity.

A transaction can be aborted at any time, in which case the state of the database must be indistinguishable from a sequence of events in which the particular transaction had never been initiated. A transaction abort is forced if a commit turns out to be impossible. An example of an impossible commit is when concurrent transactions made inconsistent modifications to the database. This is also a consequence of the requirement of atomicity.

Durability means that once a transaction has committed, its modifications to the state of the database must not be lost. If the system crashes at an arbitrary time, when the system is restarted, the database must contain all the modifications to its state made by all the transactions committed before the crash, and it must not contain any changes made by transactions which had not committed before the crash. This is called a consistent state.

If the system crashes during the commit of a transaction, on restart it must still be in a consistent state, meaning that either all or none of the modifications of that transaction are reflected in the state of the database after restart. The restart state must either be identical to the state the database would have been in if the transaction completed completely, or it must be in a state where the transaction had never been initiated. This must be true for all transactions that were active in the system when or before it crashed.

Modern DBMSes ensure atomicity in essentially one of three ways:
(i) By optimistic techniques, where a transaction's modifications to the database state are applied directly to the database, but the old values are recorded in a log, so it is possible to roll back all changes performed by the transaction should it be aborted later. As it is also necessary to recover the database state in the case of a crash, the modified values also need to be logged.
(ii) multi-version concurrency control (MVCC) is employed, where instead of modifying data, new tuples (records) are introduced, which are not made visible to other users until the transaction commits, at which time they atomically replace the old values. Tuples are associated with time stamps in this scheme. New tuples are logged when they are created, and on a restart, the time stamps on tuples and transactions are used to determine the correct, consistent state of the database.
(iii) By pessimistic techniques, which leave the database state unchanged until commit, and instead record all changes in a log, and apply them at commit time.

In case (i), (ii) or (iii), at commit time a consistency check is performed to determine whether there is an inconsistency between the state changes performed by concurrent transactions. If such an inconsistency is detected, some or all transactions must be aborted.

ACID stands for atomicity, consistency, isolation and durability of a database and a transaction log is used to ensure these characteristics. The integrity and persistence of the log is critical. In the (iii) pessimistic case, the loss of log entries due to a system crash can be tolerated as long as the transaction whose changes are being logged has not yet committed, but once the transaction has committed, it is essential that the log entries can be recovered completely in case of a crash. In the (i) optimistic or (ii) MVCC case, all logged updates must be recoverable in the case of a committed transaction.

The log is also used to record that a transaction has committed. This implies that the log, including the logging of the commit of a transaction, must be completely recoverable (in the case of a system crash) once a transaction has committed.

Specifically, the DBMS protects itself against the following classes of faults:
(i) operating-system (OS) faults, which lead to a crash of the whole system that includes the DBMS. Modern operating systems are very large, complex pieces of software that are practically impossible to guarantee to be free of faults that lead to crashes, which is why the DMBS makes the pessimistic assumption that the OS may crash at any time. Note that a DBMS does not normally attempt to protect itself against OS faults that would lead to data being corrupted while in storage, or while being written to persistent storage.
(ii) power failure, which also leads to a system failure, and loss of all non-persistent data.
(iii) hardware failures in recoverable storage devices (especially revolving magnetic disks) are typically guarded against by hardware redundancy with OS support (such as RAID). Modern DBMSes typically rely on such mechanisms to present an abstraction of reliable storage on top of hardware that is not fully reliable.

When committing a transaction, no further commits are allowed, until it is known that the log entry for the commit, plus any optimistic updates belonging to the transaction, are recorded in a way that is recoverable in the case of a system failure.

This implies that each commit constitutes a serialisation point in the operation of the DBMS, where any other commits must be deferred until the present commit has been completed, and it is known that this has been logged.

The durability and recoverability of logs is ensured by writing them to recoverable storage, typically disk or a solid-state storage device. Recoverable storage can also be described as forms of non-volatile, permanent, stable and/or persistent storage. Care needs to be taken in implementing such writes to a log to ensure that in the case of a system crash, it is always possible to determine whether the write to the log had been completed successfully (indicating a committed transaction) or was incomplete.

Transactions can only commit once the DBMS has a guarantee that the log is recoverable in case of any fault. This is normally achieved by ensuring that the data is written to recoverable storage.

FIG. 1 shows a conventional setup, where the DBMS 40 runs on top of an OS 50. The DBMS contains in its storage the volatile log storage 42 such as Random Access Memory (RAM). The OS 50 contains device drivers which control hardware devices 60 and 62. One of these device drivers 52 shown here controls the recoverable storage device 60. The DBMS 40 accesses this storage device 60 indirectly via services provided by the OS 50, which provide device access via the OS's device driver 52.

When writing log data, the DBMS 40 initially writes log data to the volatile log 42. The DBMS 40 then uses a write service provided by the OS 50, which uses the device driver 52 to send this log data to the storage device 60. The device driver 52 is notified by the device 60 when the operation is completed (and the log data safely written). This completion status is then signalled back by the OS 50 to the DBMS 40, which then knows that the data is securely written, and thus the transaction has completed. The DBMS 40 can then process other transactions.

Any discussion of documents, acts, materials, devices, articles or the like which has been included in the present specification is solely for the purpose of providing a context. It is not to be taken as an admission that any or all of these matters form part of the prior art base or were common general knowledge in the field relevant to the present invention as it existed before the priority date of each claim of this application.

### Summary

In a first aspect there is provided a computer system for writing database log data to recoverable storage comprising:
a durable database management system (DBMS);
non-recoverable storage to which log data of the DBMS is written synchronously;
a recoverable storage device driver and a recoverable storage device; and
a hypervisor or kernel in communication with the DBMS, the recoverable storage device, and having or in communication with the recoverable storage device driver, wherein the hypervisor or kernel enables:
   (i) communications between the DBMS and the recoverable storage device driver, and
   (ii) communications between the recoverable storage device driver and the recoverable storage device
      such that log data written to the non-recoverable storage is written to the recoverable storage device asynchronously to the continued writing of log data to the non-recoverable storage.

The complete processing of a transaction involves updating the data, committing these changes to the database, and writing a log for the commit. In this OS context, writing the log data asynchronously means that the DBMS need not wait for the writing of log data to the recoverable storage device to complete before continuing to process other transactions. That means that processing of the transactions by the DBMS and the write to recoverable storage can be overlapped, rather than sequential.

With known DBMSs it not possible to write commit logs to recoverable storage asynchronously. As a result, the writing of the log data has to be synchronous and this implies that logging imposes a limit on the transaction throughput of a DMBS because synchronous write operations to recoverable storage take time, and logging of commits cannot be interleaved. It is an advantage of at least one embodiment that the performance of the DBMS is improved as the overlapping of I/O operations (i.e. writing to recoverable storage) with transaction processing means processing time of the DBMS is improved without the loss of ACID properties.

In order to meet the requirement of strictly sequential commits, the log data is written from the DBMS to a non-recoverable storage synchronously. Because the non-recoverable storage is non-recoverable, this takes less time than synchronously writing to recoverable storage. The log data accumulates in the non-recoverable storage and the hypervisor or kernel writes this data in larger batches to recoverable storage asynchronously. Due to the operation of recoverable storage systems, asynchronous writing in larger batches takes less time, which leads to increased transaction throughput of the DBMS.

It is an advantage of some embodiments that since the hypervisor or kernel isolates the buffer from the DBMS (and in some embodiments the operating system also), buffering of log data is performed “outside” the DBMS (and in some embodiments operating system). It is an advantage of other embodiments that buffering of log data is done by the DBMA but protected from modifications by the DBMS or OS until written to recoverable storage. So that in the event of a crash of the DBMS (or the operating system or operating-system services), the log data written to the buffer is not lost as the system (e.g. virtual storage device or stable logging service) can still continue to write the log data to recoverable storage despite the crash. It is a further advantage that the durability of the DBMS is maintained in a way that the faster processing time advantages of using a buffer are maintained without the need for a recoverable storage buffer. The DBMS is able to continue processing transactions based on the confirmation message received from the buffer despite the log data not having yet been committed to recoverable storage.

Yet another advantage of one embodiment is that infrastructure costs for DBMs can be reduced.

### Example One and Two

In some embodiments the non-recoverable storage may be a buffer.

The hypervisor or kernel may further have or be in communication with the non-recoverable storage,
wherein the hypervisor or kernel enables communications between the DBMS and the non-recoverable storage to enable log data of the DBMS to be written to the non-recoverable storage synchronously.

### Example One

The DBMS may be in communication with an operating system (OS) that includes a virtual storage device driver, and

the hypervisor enables communications between the DBMS and the non-recoverable storage (e.g. buffer) through the virtual storage device driver. It is a further advantage that the OS needs no special modification to be used in such a computer system, it simply uses the virtual storage device driver as opposed to another device driver. It is yet a further advantage that since log data writes to a non-recoverable storage are faster than log data writes to recoverable storage, improved transaction performance can be achieved by the DBMS.

The DBMS and OS may be executable by a first virtual machine provided by the hypervisor.

The hypervisor may be in communication with the non-recoverable storage and recoverable storage device driver, the non-recoverable storage and recoverable storage device driver is provided by a second virtual machine (e.g. virtual storage device) implemented by the hypervisor. Alternatively, the functionality of the non-recoverable storage and recoverable storage device driver may be incorporated into the hypervisor itself.

### Example 2

The kernel may be a microkernel, such as seL4.

The DBMS may be in communication with a logging service, and the logging service is in communication with the non-recoverable storage (e.g. buffer), and
the kernel enables communications between the DBMS and the non-recoverable storage through the logging service.

The logging service may be encapsulated in its own address space implemented by the kernel. Alternatively, it may be incorporated within the kernel.

The recoverable storage device driver may be encapsulated in its own address space implemented by the kernel. Alternatively, the recoverable storage device may be incorporated within the kernel.

The kernel may further enable communication between the non-recoverable storage and the recoverable storage device driver.

### Dependent Claims Example One and Two

The storage size of the non-recoverable storage is based on an amount of log data that can be written to the recoverable storage device in the event of a power failure in the computer system. It is an advantage of this embodiment that none of the log data in the non-recoverable storage is lost in the event of a power failure.

In the event of a power failure the hypervisor or kernel may disable communications between the DBMS and non-recoverable storage (e.g. enable only communications between recoverable device driver and the recoverable storage device).

Communications between the DBMS, and the non-recoverable storage may include temporarily disabling the log data of the DBMS being written to the non-recoverable storage if there is not sufficient space in the non-recoverable storage to store the log data.

The hypervisor, kernel and/or recoverable storage device driver may be reliable, that is provides guarantee that it will function correctly, for example is verified. It is an advantage of at least one embodiment that use of a reliable hypervisor and/or reliable non-volatile storage device driver helps to prevent violation of the DBMS's durability by assisting to ensure that log data stored in the non-recoverable storage is not lost before it can be written to the recoverable storage.

The communications between the DBMS and the non-recoverable storage may include a confirmation message sent to the DBMS indicative that the log data has been durably written when written to the non-recoverable storage.

The communications between the DBMS and the non-recoverable storage and the communications between the recoverable storage device driver and a recoverable storage device may be enabled to occur concurrently.

It is a further advantage of at least one embodiment that the DBMS retains the ACID properties.

### Example Three

The non-recoverable storage may be volatile memory that the DBMS runs on. The hypervisor or kernel may further enable mapping of the non-recoverable storage such that the recoverable storage device driver utilises this mapping to access the log data written to the non-recoverable storage.

### The Method as Performed by the Hypervisor or Kernel

In a second aspect there is provided a method performed by a hypervisor or kernel of a computer system to cause database log data that is written synchronously to non-recoverable storage to be stored in recoverable storage, wherein the hypervisor or kernel is in communication with a durable database management system (DBMS), a recoverable storage device, and having or in communication with the recoverable storage device driver, the method comprising:
enabling communications between the DBMS and the recoverable storage device driver; and
enabling communications between the recoverable storage device driver and the recoverable storage device,
   such that log data written to the non-recoverable storage is written to the recoverable storage device asynchronously to the continued writing of log data to the non-recoverable storage.
   The Method as Performed by the Virtual Storage Device or Logging Service (which can Also be the Hypervisor or Kernel)

In a third aspect there is provided a method to enable database log data to be stored in recoverable storage comprising:
receiving a data log write request from a durable database management system (DBMS) via a hypervisor or kernel;
writing the log data to a non-recoverable storage or accessing log data previously written to the non-recoverable storage; and
causing the log data written to the non-recoverable storage to be written to a recoverable storage device asynchronously to continued writing of log data to the non-recoverable storage.

Causing may be by way of sending a request to write message or acting as an intermediary to have the request to write message sent.

Accessing may based on using mapping to the volatile memory that the DBMS runs on.

In a fourth aspect there is provided software, that is computer executable instructions stored on computer readable media, that when executed by a computer causes it perform the method of the second and third aspects.

Optional features of the computer system described above are also optional features of this method of the second, third and fourth aspects.

### Old Claim One

In yet a further aspect there is provided a computer system for writing database log data to recoverable storage comprising:
a durable database management system (DBMS); and
a hypervisor or kernel in communication with the DBMS, and having or in communication with a non-recoverable storage buffer and a recoverable storage device driver, wherein the hypervisor or kernel enables:
   (i) communications between the DBMS and the buffer to enable log data of the DBMS to be written to the buffer synchronously; and
   (ii) communications between the recoverable storage device driver and a recoverable storage device to enable the log data written to the buffer to be written to recoverable storage device asynchronously to continued writing of log data to the buffer.

Optional features described above are also optional features of this further aspect of the invention.

### BRIEF DESCRIPTION OF THE DRAWINGS

FIG. 1 schematically shows the conventional design of a DBMS.

Examples of the invention will now be described with reference to the accompanying drawings in which:

FIG. 2 schematically shows the design of a DBMS according to a first example.

FIG. 3 to FIG. 7 are simplified flow charts showing the operation of a virtual device according to the first example.

FIG. 8 schematically shows the design of a DBMS according to a second example.

FIG. 9 schematically shows the design of a DBMS according to a third example.

### BEST MODES

In these examples a unique buffering system is added between the DBMS and the recoverable storage. The performance benefits include removing the need for synchronous writes to the recoverable storage which are slow and during this time most other DBMS activities are blocked. In these examples writes to recoverable storage is performed asynchronously to DBMS operation, overlapping write operations with transaction processing and smoothing out a fluctuating database load thus allowing improved performance by concurrent processing of transactions and doing writes to recoverable storage in larger batches. This decreases latency and increases throughput respectively.

Batching writes has a few advantages where a buffering system is used. Disk writes cannot be smaller than the disk block size, and the OS often writes even larger blocks anyway. Without buffering, very small writes to the transaction log incur the same I/O expense as block-sized writes.

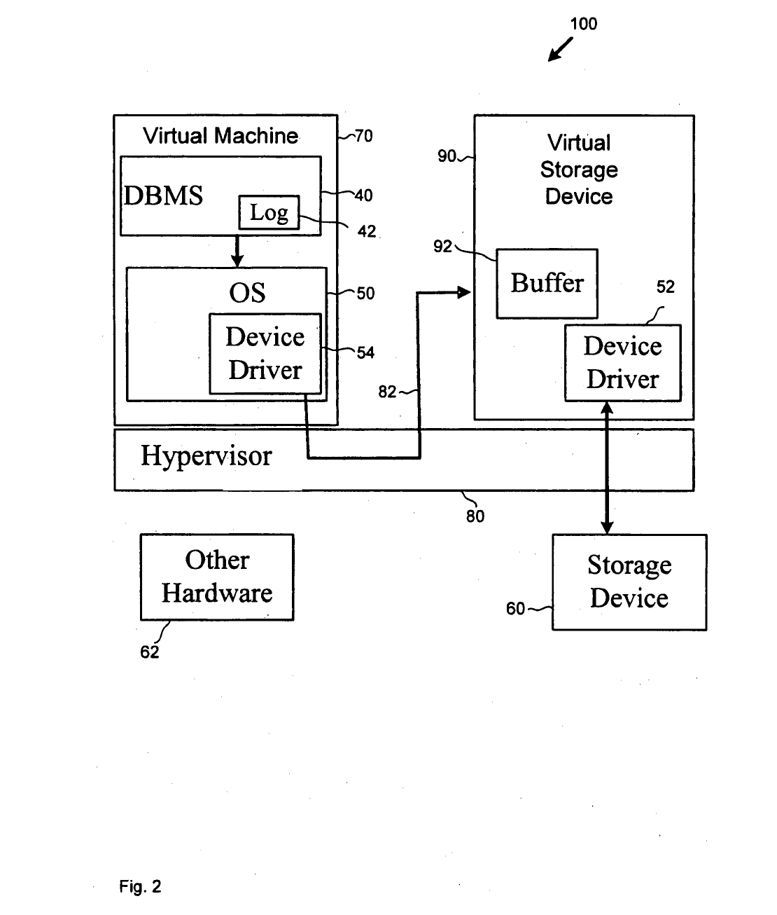

FIG. 2 shows schematically the design of a computer system 100 of a first example. The DBMS 40 runs on the OS 50, such as Linux, as before. No special modification to the DBMS 40 is made in this example to account for the new design however the DBMS 40 is running in a virtual machine 70 which communicates with a virtual storage device 90 as described here.

The OS 50 again provides storage service to the DBMS 40 via a device driver 54, which the DBMS 40 uses to write the volatile log 42 to recoverable storage 60. However, in this case the OS 50 does not access real hardware 60 and 62, but it runs inside a virtual machine 70 which is implemented/enabled by a hypervisor 80. In particular, the OS's device driver 54 does not interact with a real device 60, but interacts with a virtual device 90.

The second virtual machine, being the virtual device 90, is also an abstraction implemented/enabled by the hypervisor 80. It provides virtual storage, which it implements with, among others, the real storage device 60, a device driver 52 for the real storage device 60, and a buffer 92. The buffer 92 is high speed volatile storage.

The hypervisor 80 is in communication with virtual machines 70 and 90, keeping the machines 70 and 90 separated and enables communication 82 between them and between the device driver 52 and the storage device 60.

A write of log data performed by the DBMS 40 in this scenario uses the OS's device driver 54 to send the data to the virtual device 90 rather than the storage device 60. The virtual device 90 reliably stores the data in the buffer 92, and signals completion of the operation back to the OS 50, which informs the DBMS 40. The DBMS 40 then knows that the transaction has completed and can process further transactions.

The virtual device 90, meanwhile, sends the log data to the recoverable storage device 60 via the driver 52 asynchronously (and concurrently) to the continuing operation of the DBMS 40. That way, the DBMS 40 does not wait until the data is stored on recoverable storage 60.

The hypervisor 80 is formally verified, in that it offers high level of assurance that it operates correctly, and in particular does not crash. In this example the hypervisor uses seL4 that is the formally verified microkernel of [1]. Formal verification gives us a high degree of confidence in its reliability properties. This example leverages off this reliability in order to deliver strong reliability guarantees without the costs of synchronous writes to recoverable storage. In particular, the hypervisor 80 permits the creation of isolated components such as the virtual machine 70 and virtual device 90 that are unable to interfere with each other. Inter-process communication (IPC) 82 is permitted between them 54 and 90 to allow them to exchange information as described in further detail below. The use of a reliable formally verified hypervisor 80 in the system 100 attracts other reliability benefits, such as reducing the impact of malicious code.

In other alternatives, hypervisor 80 may not be verified, or other components may not guarantee high dependability; however this alternative represents a tradeoff in the assurance of the dependability of the system. Other approaches provide less assurance making selecting the reliability of the hypervisor 80 a tradeoff choice.

Also in this example the virtual storage device 90 is a highly reliable virtual disk (HRVD). This software component runs on the same hardware as the OS 50, but through the use of the hypervisor 80 they 50 and 90 are kept safely separate. The HRVD 90 does not depend on, and cannot be harmed by, the OS 50. The OS 50 treats the HRVD 90 as a block device (hence the name “virtual disk”). When the OS 50 issues log writes to the HRVD 90, the log data therein is safeguarded in a buffer 92 such as RAM so that the OS 50 cannot corrupt it, and then the OS 50 is informed that the write is complete. The HRVD 90 will write outstanding log data to a recoverable memory 60, such as a magnetic disk or non-volatile solid state memory device concurrently to the DBMS 40 processing data.

It is preferred that the device driver 52 is also highly dependable. In this example, this is achieved by only optimising the device driver 52 for the requirements of the HRVD 90, and it is preferably formally verified. Alternatively, the device driver 52 can be synthesised from formal specifications and therefore is dependable by construction. The device driver 52 provides much less functionality than a typical disk driver, as during normal operation the device driver 52 only needs to deal with sequential writes, particularly if the database log is kept on a storage device separate from the device which holds the actual database data. This greatly simplifies the driver, making it easier to assure its dependability.

A simplified example of the IPC 82, being high throughput, low-latency communication, will now be described. The entirety of the DBMS's virtual “physical” memory is mapped into the HRVD's 90 address space. When the database OS 50 wants to read or write log data 42, it passes via IPC 82 to the HRVD 90 a pointer referencing the data. In the case of writes, the HRVD 90 would copy the data into its own buffers 92 (which cannot be accessed by the database's virtual machine 70), thus securing the log data, before replying to the OS 50 via IPC 82. In this example, a pointer referencing the log data, a number indicating the size of the data to be written, and a block number referencing a destination location on the virtual storage device, and a flag indicating a write operation, are sent in the IPC 82 message. The reply IPC 82 message from the HRVD 90 to the OS 50 will indicate success or failure of the operation. The HRVD 90 runs at a higher priority then the OS 50, which means that from an OS perspective, writes are atomic, which reduces risk of data corruption.

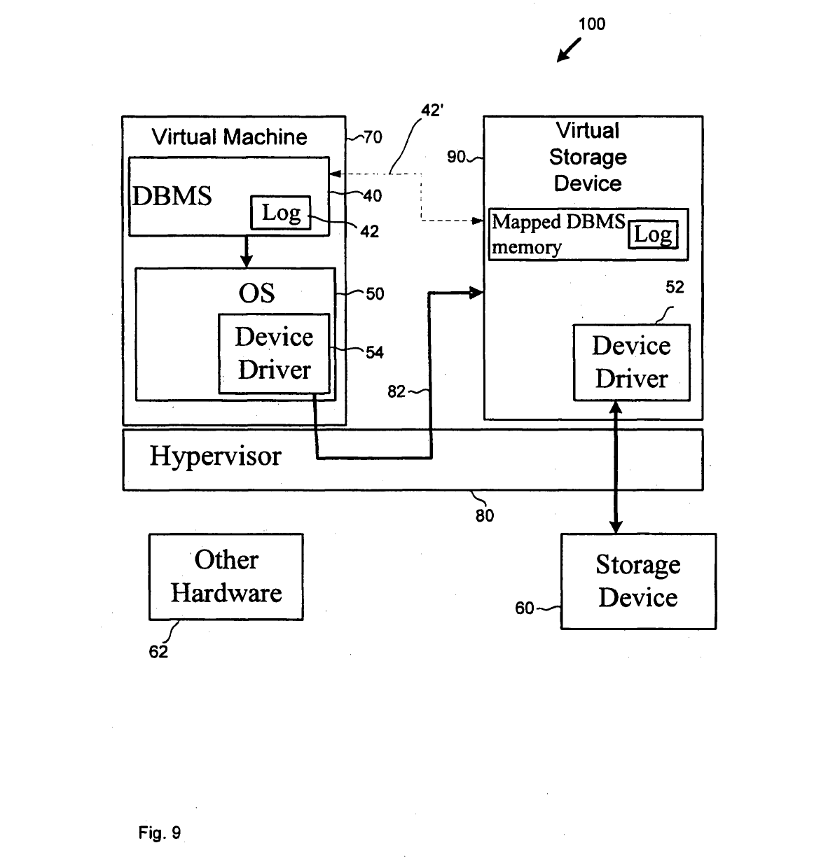

FIG. 9 shows a further example that will now be described that eliminates the copying of the volatile log data 42 to a volatile buffer 92. In order to prevent the DBMS 40 from modifying the volatile log data 42 before it is written to recoverable storage 60, the virtual storage device 90 via mechanisms provided by the hypervisor 80 temporarily changes the virtual address space mappings 42′ of the region of the DBMS's 40 address space containing the volatile log data 42 as a way to secure the log data. The DBMS can then be allowed to continue transaction processing. Once the log data is written to recoverable storage 60, the virtual storage device 90 restores the DBMS's write access to its virtual memory region holding the volatile log data 42. Should the DBMS 40 attempt to modify the volatile log data 42 before the virtual storage device 90 has completed writing to recoverable storage 60, the memory-management hardware will cause the DBMS 40 to block and raise an exception to the hypervisor. In such a case, the virtual storage device will unblock the DBMS 40 after restoring the DBMS's 40 write access to the volatile log 42.

This variant has the advantage that it saves the copy operation from the volatile log 42 to the buffer 92, which may improve overall performance, but requires changing storage mappings 42′ twice for each invocation of the virtual storage device 90. Since DBMS 40 is unable to modify the volatile log 42 until it is written to recoverable storage 60, in some embodiments this may reduce the degree of concurrency between transaction processing and writing to recoverable storage 60. This can be mitigated by the DBMS 40 spreading the volatile log 42 over a large area of storage and maximising the time until it re-uses (overwrite) any particular part of the log area, in conjunction with the virtual storage device 90 carefully minimising the amount of the DBMS's 40 storage which it-protects from write access.

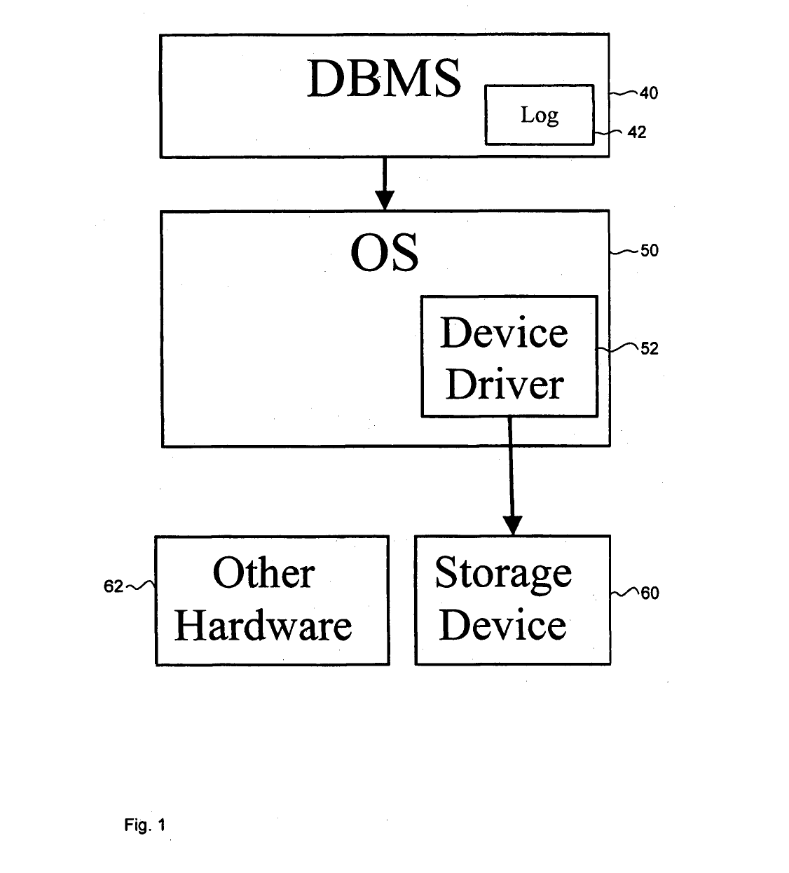

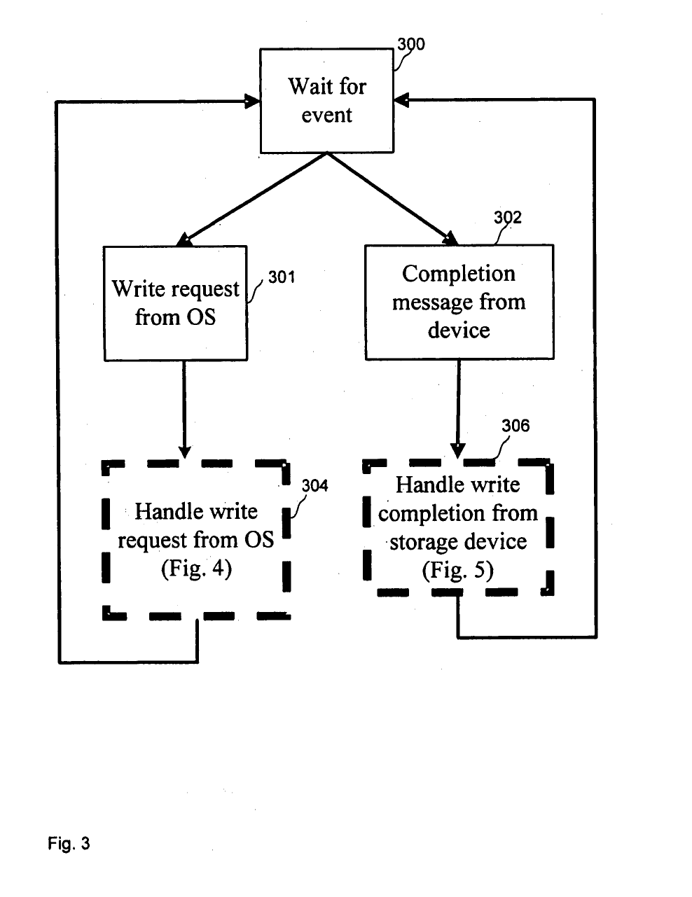

The flow charts of FIGS. 3 to 5 and FIG. 7 summarise the operation of the virtual device 90 of FIG. 1 and will now be discussed in more detail. Similar to a normal storage device 60, the virtual device 90 reacts to requests 82 from the OS 50 (issued by the OS's device driver 54) and signals 82 completions back to the OS 50.

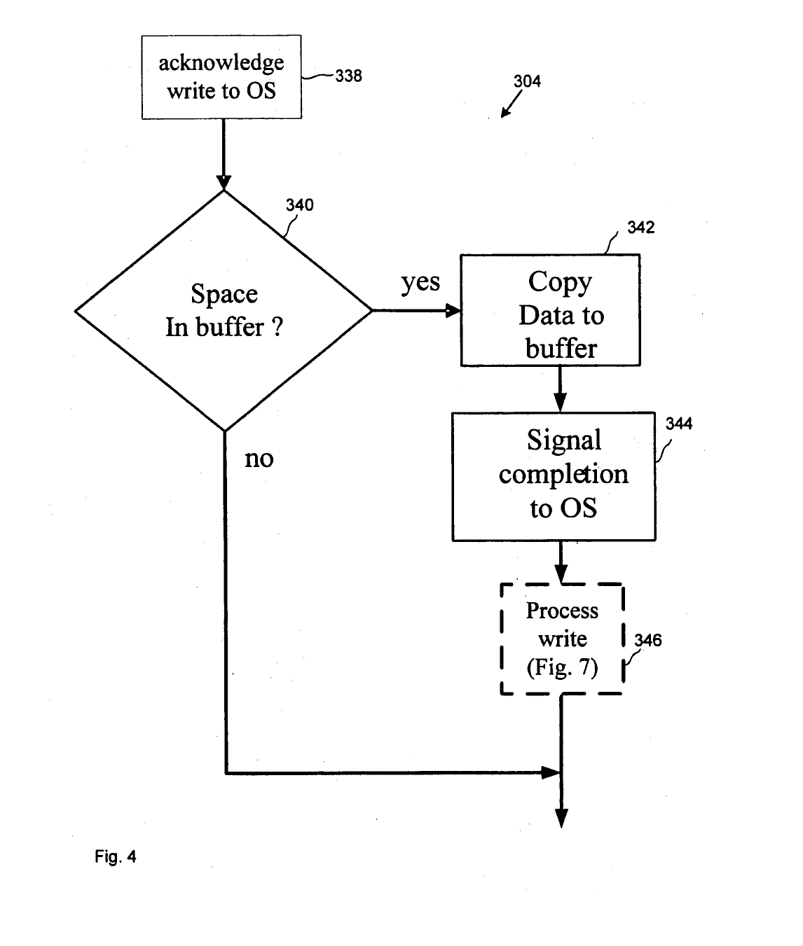

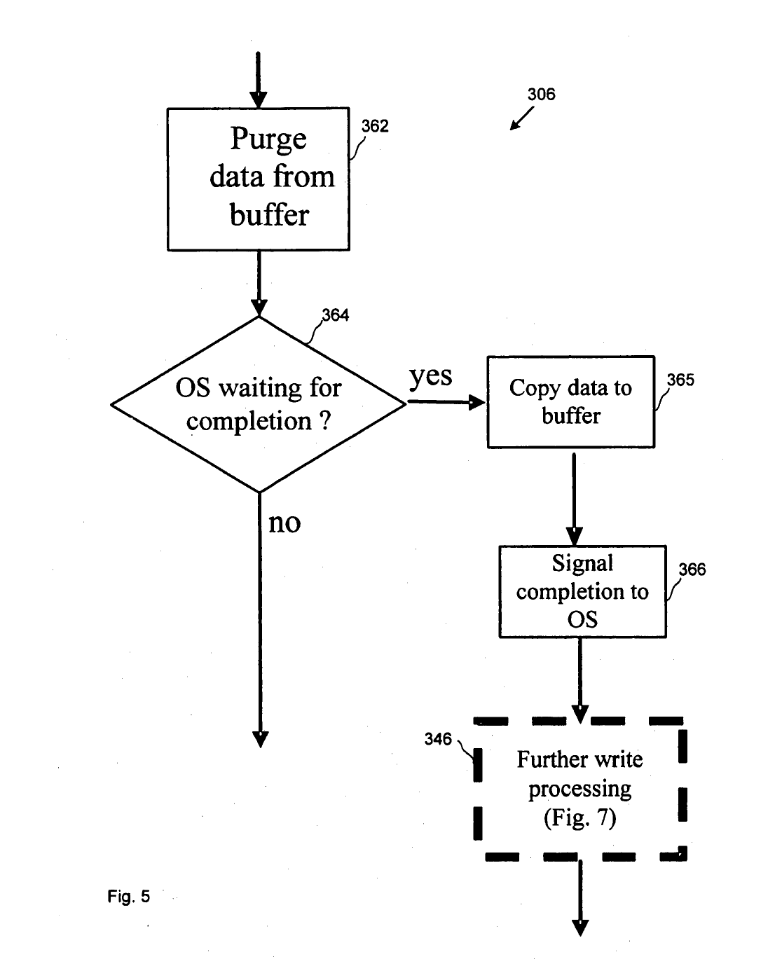

As shown in FIG. 3, the virtual storage device 90 has an initial state 300 where it is blocked, waiting for an event. The kinds of events that the virtual device 90 can receive include a request 301 from the OS 50 to write data, and a notification 302 from the recoverable storage device 60 that a write operation initiated earlier by the device driver 52 has completed. In the first case 301, the virtual device 90 handles 304 the write request (as shown in FIG. 4), in the second case 302 it handles 306 the completion request (as shown in FIG. 5).

FIG. 4 provides details of the handling of the write request 304. The virtual device 90 acknowledges 338 the write request 301 to the OS, to inform the OS that it is safe to continue operation, while the actual processing of the write request is performed by the virtual device 90 as described below.

If 340 there is sufficient spare capacity in the buffer 92, the virtual device 90 stores 342 the log data in the buffer 92 and signals 344 completion of the write operation to the OS 50, then performs write processing 346. Only in the case of insufficient free buffer space is the completion of the write not signalled promptly to the OS 50.

FIG. 5 shows the handling of the completion message 306 from the recoverable storage device 60. The log data that has been written to the recoverable storage device 60 is purged 362 from the buffer 92, freeing up space in the buffer 92. If the OS 50 is still waiting for completion of an earlier write operation, data is copied to the buffer 365 and completion is now signalled 366 to the OS 50. The virtual device 90 then performs 346 further write processing.

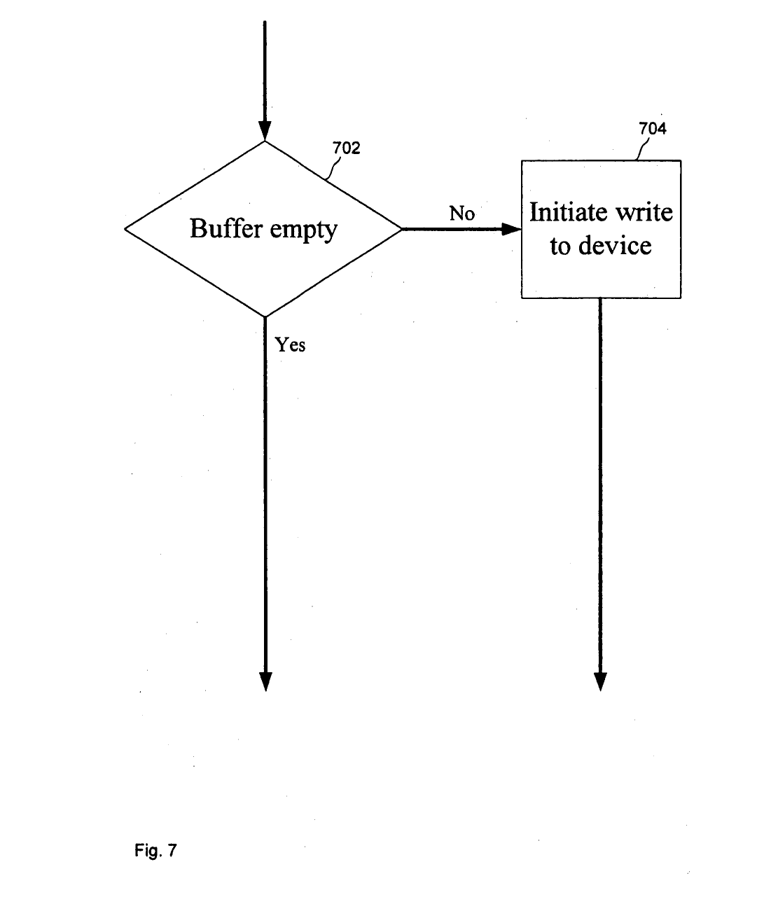

FIG. 7 shows the write processing 308 by the virtual device 90. If the buffer 92 is not empty 702, a write operation to the storage device 60 is initiated 704 by invoking the appropriate interface of the device driver 52.

Once the OS 50 receives the completion message 344 or 366, this is the indication that the log data is stable. The DBMS 40, which had requested to block until data is written to recoverable storage (either by using a synchronous write API or following an (asynchronous) write with an explicit “sync” operation) can now be unblocked by the OS 50.

To increase efficiency, the method of FIG. 7 can be extended to check prior to initiating a write operation to the storage device 60 if the buffer 92 contains a minimum amount of data (such as one complete disk block), and only writing complete blocks at a time. This will maximise the use of available bandwidth to the storage device 60.

For simplicity, the handling of the two kinds of events 304 and 306 have been shown as alternative processing streams in FIG. 3. Alternatively, the two processing streams can be overlapped.

Also for simplicity, the described procedure assumes that the recoverable storage device 60 can handle multiple concurrent write requests 346. Alternatively, the device may not have this capability and a sequential ordering may be imposed on the write requests. In this case, the process write operation 346 can only initiate a new write to the storage device 60 once the previous one has completed.

This operation of the virtual device is possible without violating the DBMS's 40 durability requirements, as long as the virtual device 90 can guarantee that data it has buffered in buffer 92 is never lost before being written on the recoverable storage device 60. In this example to ensure this, the virtual device 90 must satisfy two requirements:
(i) That the virtual device 90 will never crash. Guaranteeing that the virtual device 90 will never crash requires a guaranteeing that the hypervisor 80 will never crash, as a crash of the hypervisor 80 implies a loss of data buffered 92 by the virtual device 90 proper. Furthermore, it requires guaranteeing that, assuming the hypervisor 82 operates as specified, the virtual device 90 will never lose its data. This includes guaranteeing that the virtual device 90 will not lose log data in the case of a power failure. This requirement is met in this example by using a proven-to-be-crash-free virtual device 90 and sizing the buffer 92 such that its contents can be written to the storage device 60 in the time remaining after a power outage is detected and before the buffer 92 is lost or the system stops functioning correctly.
(ii) It may not be necessary to protect against power failure (e.g. because an uninterruptible power supply (UPS) is being used. However, when this is not the case and power failure happens, all data in the buffer 92 will be written to recoverable storage 60 before its volatile memory (that is the data in the buffer 92) is lost. This is achieved in this example by ensuring that in case of a power failure, enough time remains to write the buffered log data to recoverable storage 60.

In that case, the buffer can be made very large, which may lead to improved performance. In order to ensure that no logging data is lost on a power failure, the virtual storage device 90 must be notified when power fails. It furthermore must know how much time it has in the worst case from the time of the failure until the system 100 can no longer operate reliably, including writing to the recoverable storage device 60 and retaining the contents of volatile memory 92. It finally must know the worst case duration of writing any data from volatile memory 92 to the recoverable storage device 60.

With this knowledge, the virtual storage device 90 is configured to apply a predetermined capacity limit on its buffer 92 to ensure that in the case of a power failure, all buffer 92 contents are safely written to the recoverable storage device 60. Alternatively, the capacity of the buffer may be dynamically set, for example based on the above parameters that the device 90 must know and may change over time.

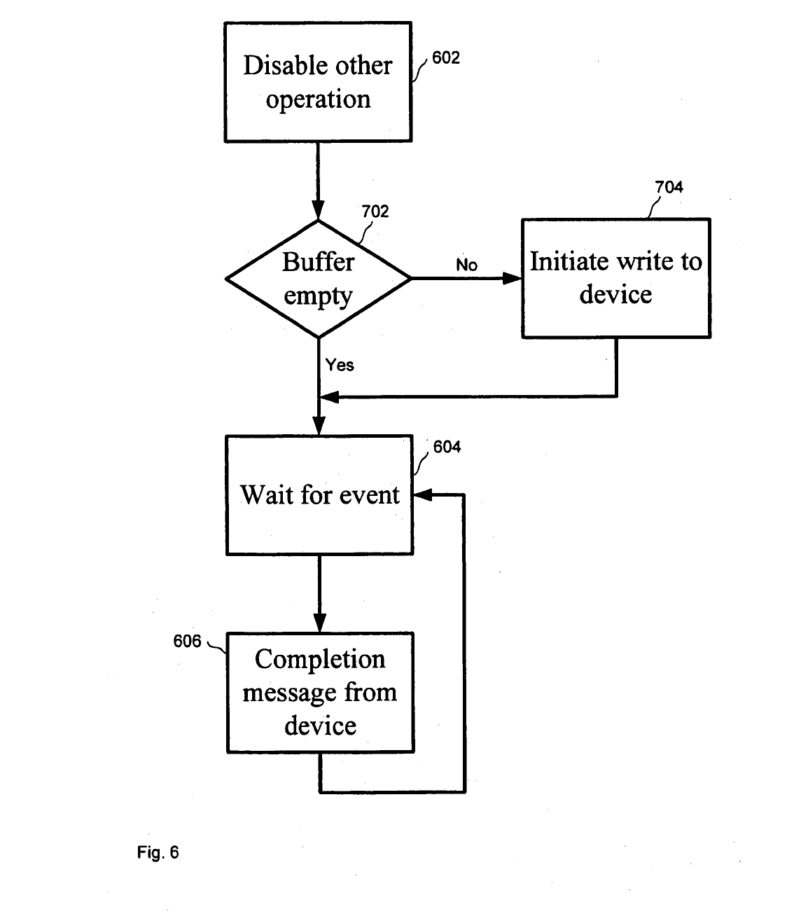

When a power failure happens, the virtual storage device 90 immediately changes its operation from the one described with reference to FIG. 3 to the one described in FIG. 6. Specifically, when notified of a power failure, the virtual device 90 instructs 82 the hypervisor 80 to ensure that the virtual machine 70 of the DBMS 40 can no longer execute 602. This is typically done by such means as disabling most interrupts, making the DMBS's virtual machine 70 non-schedulable etc.

Next, the virtual device 90 ensures that any remaining data is flushed from the buffer 92. It checks 702 whether there is any data left to write in the buffer 92, and if so, initiates 704 a final write request to the recoverable storage device 60.

The virtual device 90 then waits 604 for events, which can now only be notifications 606 from the recoverable storage device 60 indicating that pending write operations have concluded. These require no further action, as the system is about to halt and lose its volatile data 92. The virtual storage device 90 in this mode only ensures that the write operations to the recoverable storage device 60 can continue without interference.

Alternatively, the virtual storage device 60 may be able to recover and return to the operation shown in FIG. 3 by enabling the DBMS 40 should power supply be reconnected before the system 100 becomes inoperable.

It should be understood that the virtual storage device 90 can be adapted to operate as a virtual disk for multiple OS/DBMS clients. This is most advantageous in a virtual-server environment.

It should also be understood that while only the operation of write operations are described above, the any reads of database data can be handled by the virtual storage device 90, or database data can be kept on a device different from the storage device 60 which is used to keep the database log data.

Also, the system can be optimised by adapting the IPC in a manner that best suits the block size of the write requests to prevent multiple writes for the one request.

In an alternative to the first example described with reference to FIG. 2, we note that the computer system could be designed with only one virtual machine having the OS 50 and DBMS 40. In this alternative, the virtual storage device 90 could be merged with the hypervisor 80. That is the hypervisor would provide the functionality previously described in relation to the separate virtual storage device 90. In that case, the real device driver 52 would become part of the hypervisor 80. The rest of the functionality of the virtual storage device, including buffering 92, would either become part of the hypervisor, or execute outside the hypervsior proper (whether or not the environment in which that functionality is implemented has the full properties of a virtual machine). No changes to the OS 50 or DBMS 40 is required to implement this alternative of the first example.

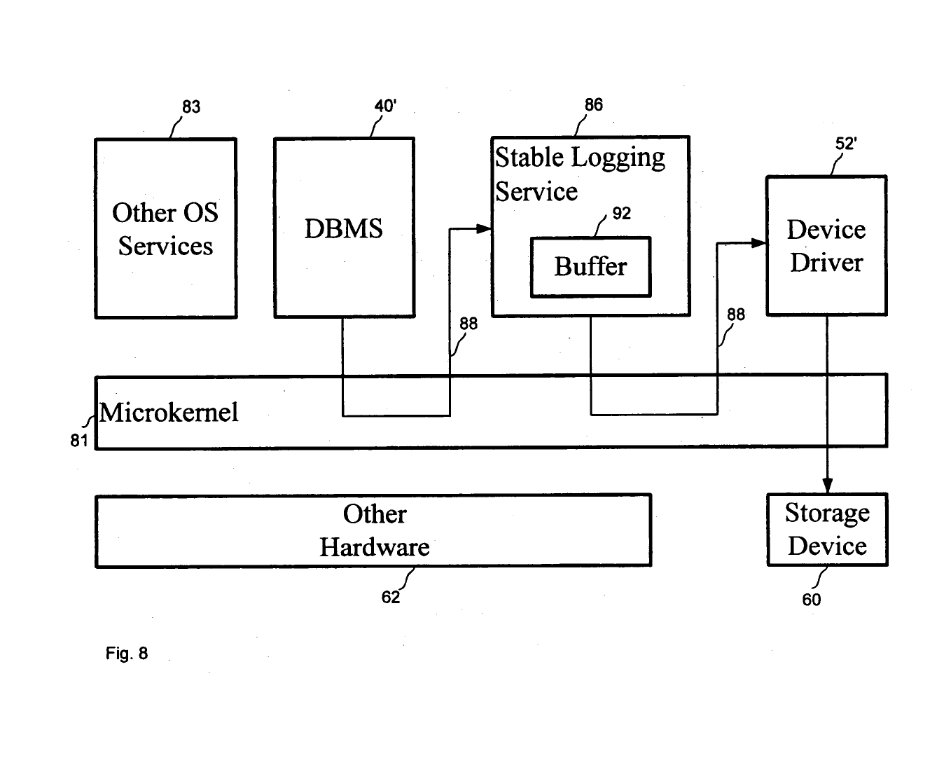

A second example will now be described with reference to FIG. 8 which shows the DMBS implementation using a microkernel 81 instead of a hypervisor 82 of the first example.

Compared to the first example, the example of FIG. 8 requires significant changes to the implementation of the DBMS 40′, and is therefore mostly attractive when writing a DBMS 40′ from scratch so that it makes optimal use of a reliable kernel 81.

Instead of using a standard I/O interface as provided by OSes (which could be synchronous I/O APIs or asynchronous APIs plus explicit “sync” calls), the DBMS 40′ uses a stable logging service 86, designed specifically for the needs of the DBMS 40′, which is implemented directly on top of the microkernel 81.

Here the DBMS 40′ runs in a microkernel-based environment. OS services are provided by one or more servers, which could be executing in a user-mode environment or as part of the kernel. Preferably, the OS services are outside the kernel 81, as this minimises the kernel 81, which in turn facilitates making the kernel reliable due to its smaller size.

If the services execute in user mode, they are invoked by a microkernel-provided communication mechanism (IPC) 88. This IPC-based communication of the DBMS 40′ with OS services 83 may be explicit or hidden inside system libraries which are linked to the DBMS 40′ code.

One such service is the logging service 86 which is used by the DBMS 40′ to write log data. It consists of a buffer 92 and associated program code, which is protected from other system components 40′, 83 and 52 by being encapsulated in its own address space.

The DBMS 40′ sends its logging data 42 via the IPC 88 to the logging service 86, which synchronously writes it in the buffer 92, and from there asynchronously 88 to recoverable storage 60 via the device driver 52′.

The principle of the operation is similar to the virtualization of the first example. However, compared to the virtualization approach, this design requires changes to the DBMS 40′, which needs to be ported from a standard OS environment to the microkernel-based environment (or designed from scratch for that environment). The effort to do this can be reduced if the microkernel-based OS services adhere to standard OS APIs as much as possible, some of which can be achieved by emulating standard OS APIs in libraries. It is also possible to provide most OS services by running a complete OS inside a virtual machine (where the microkernel acts as a hypervisor).

However, this design can lead to simplifications in the design and implementation of the DBMS, as some of the logic dealing with stable logging is now provided by the microkernel-based logging service 86, and can be removed from the DBMS 40′. This is especially advantageous if a DBMS 40′ is designed from scratch for this approach.

As an alternative to second example, the logging service 86 can be implemented inside the microkernel 81. Correct operation of the microkernel 81 and the logging service 86 are equally critical to the stability of the DBMS log, and for achieving reliability there is not much difference between in-kernel and user-mode implementation of this service 86. However, keeping the logging service 86 in user mode has the advantage that the reliability of kernel 81 and logging service 86 can be established independently. As the kernel 81 is a general-purpose platform, it may be readily available and its reliability already established, as in the case of the seL4 microkernel. It is then best not to modify it in any way, in order to maintain existing assurance. Establishing the reliability of the logging service 86 (ideally by formal proof of functional correctness) can then be made on the basis of the kernel 81 being known to be reliable.

A similar alternative applies to the device driver 52′, which also could be inside the kernel 81 or in user mode, and in the latter case, encapsulated in its own address space or co-located in the address space of the logging service 86. User-mode execution in its own address space allows establishing its reliability independent of the other components 81 and 86.

Operation of the logging service 86 is completely analogous to the virtual storage device 90 of the first example. If the service 86 provides an asynchronous interface (using send-data, acknowledge-data, write-completed operations) then the methods shown in FIGS. 3 to 7 apply to this second example where the operations of the OS 50 are replaced by DBMS 40′.

Alternatively, the logging service can provide a synchronous interface, with a single remote procedure call (RPC) style write operation. In this case, the “acknowledge write to OS” is omitted, and “signal completion to OS” is replaced by having the write call return to the DBMS.

It should be appreciated that guaranteeing the correct behaviour of the disk driver 52 can be addressed in a number of ways. For example, a driver can be formally verified, providing mathematical proof of its correct operation, or a driver can be synthesised from formal specifications thus ensuring that is correct by construction. In a further alternative, it can be developed using a co-design and co-verification approach.

Alternatively, to ease the requirement for driver reliability, two disk drivers could be used in the virtual storage device: (a) a standard, traditional (unverified) driver and (b) a very simple, guaranteed-to-be-correct “emergency” driver. The emergency driver can be much simpler than a normal driver.

The standard driver is encapsulated in its own address space, such that it can only access its own memory. The standard driver is not given access to any of the I/O buffers that are to be read from/written to disk. Instead the virtual device infrastructure makes the buffers selectively available, on an as-needed basis, to the device. This can be achieved with I/O memory-management units (IOMMUs) which exist on some modern computing platforms.

The emergency driver is only able to perform sequential writes to the storage device. It is simple enough to be formally verified and even simpler to be synthesised, or traditional methods of testing and code inspection can be used to ensure its correct operation with a very high probability.

The standard driver is used during normal operation. The standard driver is disabled and the emergency driver invoked in one of two situations:
(i) the standard driver crashes or attempts to performs an invalid access (memory protection violation) or becomes unresponsive
(ii) a power failure is detected, requiring flushing of the buffers to disk.

On invocation of the emergency driver, the virtual machine containing the DBMS is prevented from running. The emergency driver is used to flush all remaining unsaved buffer data to the storage device. After that, the system is shut down (whether or not there is a power failure), requiring a restart (and standard database recovery operation).

An interim scheme would be to use separate drivers for database recovery and during normal operation. The database log is only ever written during normal operations, read operations are only needed during database recovery. A standard driver could be used during recovery, and a simplified driver that can only write sequentially during normal operation. Such a driver would be much simpler than a normal driver, although slightly more complex than an emergency-only driver. In this case, the database data are kept on a different storage device 60 than the log data, allowing reads and writes of database data to be performed by a device driver separate from the device driver 52 used to write the log data.

It should be understood that the techniques of the present disclosure might be implemented using a variety of technologies. For example, the methods described herein may be implemented by a series of computer executable instructions residing on a suitable computer readable medium. Suitable computer readable media may include volatile (e.g. RAM) and/or non-volatile (e.g. ROM, disk) memory, carrier waves and transmission media. Exemplary carrier waves may take the form of electrical, electromagnetic or optical signals conveying digital data streams along a local network or a publicly accessible network such as the internet.

It should also be understood that, unless specifically stated otherwise as apparent from the following discussion, it is appreciated that throughout the description, discussions utilizing terms such as “enabling” or “writing” or “sending” or “receiving” or “processing” or “computing” or “calculating”, “optimizing” or “determining” or “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices.

It will be appreciated by persons skilled in the art that numerous variations and/or modifications may be made to the invention as shown in the specific embodiments without departing from the scope of the invention as broadly described. The present embodiments are, therefore, to be considered in all respects as illustrative and not restrictive.

### REFERENCES

[1] G. Klein, K. Elphinstone, G. Heiser, J. Andronick, D. Cock, P. Derrin, D. Elkaduwe, K. Engelhardt, R. Kolanski, M. Norrish, T. Sewell, H. Tuch, and S. Winwood. seL4: Formal verification of an OS kernel. In Proceedings of the 22nd ACM Symposium on Operating Systems Principles, pages 207-220, Big Sky, Mont., USA, October 2009. ACM.

1. A computer system for writing database log data to recoverable storage comprising:
a durable database management system (DBMS);
non-recoverable storage to which log data of the DBMS is written synchronously;
a recoverable storage device driver and a recoverable storage device; and
a hypervisor or kernel in communication with the DBMS, the recoverable storage device, and having or in communication with the recoverable storage device driver, wherein the hypervisor or kernel enables:
(i) communications between the DBMS and the recoverable storage device driver, and
(ii) communications between the recoverable storage device driver and the recoverable storage device
such that log data written to the non-recoverable storage is written to the recoverable storage device asynchronously to the continued writing of log data to the non-recoverable storage.

2. The computer system of claim 1, wherein the hypervisor further enables communications between the DBMS and the non-recoverable storage to enable log data of the DBMS to be written to the non-recoverable storage.

3. The computer system of claim 1, wherein the DBMS is in communication with an operating system (OS) that includes a virtual storage device driver, and
the hypervisor enables communications between the DBMS and the non-recoverable storage through the virtual storage device driver.

4. The computer system of claim 3, where the DBMS and OS are executable by a first virtual machine provided by the hypervisor.

5. The computer system of claim 1, where the hypervisor is in communication with the non-recoverable storage and recoverable storage device driver, the non-recoverable storage and recoverable storage device driver is provided by a second virtual machine.

6. The computer system of claim 1, wherein the DBMS is in communication with a logging service, and the logging service is in communication with the non-recoverable storage, and
the kernel enables communications between the DBMS and the non-recoverable storage through the logging service.

7. The computer system of claim 6, wherein the logging service is encapsulated in its own address space implemented by the kernel.

8. The computer system of claim 1, wherein the recoverable storage device driver is encapsulated in its own address space implemented by the kernel.

9. The computer system of claim 1, wherein the kernel further enables communication between the non-recoverable and the recoverable storage device driver.

10. The computer system according to claim 1, such that the storage size of the non-recoverable storage is based on an amount of log data that can be written to the recoverable storage device in the event of a power failure in the computer system.

11. The computer system according to claim 10, wherein in the event of a power failure the hypervisor or kernel disables communications between the DBMS and non-recoverable storage.

12. The computer system according to claim 1, wherein the hypervisor, kernel and/or storage device driver is reliable.

13. The computer system according to claim 2, wherein communications between the DBMS and the non-recoverable storage includes a confirmation message sent to the DBMS indicative that the log data has been durably written when written to the non-recoverable storage.

14. The computer system according to claim 1, wherein writing of log data to the non-recoverable storage and the communications between the recoverable storage device driver and a recoverable storage device is enabled to occur concurrently.

15. The computer system according to claim 1, wherein the hypervisor or kernel further enables mapping of the non-recoverable storage such that the recoverable storage device driver utilizes this mapping to access the log data written to the non-recoverable storage.

16. A method performed by a hypervisor or kernel of a computer system to cause database log data that is written synchronously to non-recoverable storage to be stored in recoverable storage, wherein the hypervisor or kernel is in communication with a durable database management system (DBMS), a recoverable storage device, and having or in communication with the recoverable storage device driver, the method comprising:
enabling communications between the DBMS and the recoverable storage device driver; and
enabling communications between the recoverable storage device driver and the recoverable storage device,
such that log data written to the non-recoverable storage is written to the recoverable storage device asynchronously to the continued writing of log data to the non-recoverable storage.

17. A method to enable database log data to be stored in recoverable storage comprising:
receiving a data log write request from a durable database management system (DBMS) via a hypervisor or kernel;
writing the log data to a non-recoverable storage or accessing log data previously written to the non-recoverable storage; and
causing the log data written to the non-recoverable storage to be written to a recoverable storage device asynchronously to continued writing of log data to the non-recoverable storage.

18. Software, that is computer executable instructions stored on computer readable media, that when executed by a computer causes it to perform the method of claim 16.

19. A computer system for writing database log data to recoverable storage comprising:
a durable database management system (DBMS); and
a hypervisor or kernel in communication with the DBMS, and having or in communication with a non-recoverable storage buffer and a recoverable storage device driver, wherein the hypervisor or kernel enables:
(i) communications between the DBMS and the buffer to enable log data of the DBMS to be written to the buffer synchronously; and
(ii) communications between the recoverable storage device driver and a recoverable storage device to enable the log data written to the buffer to be written to recoverable storage device asynchronously to continued writing of log data to the buffer.
